(19) United States
(12) Patent Application Publication
(10) Pub. No.: US 2025/0150955 A1
(43) Pub. Date: May 8, 2025

(54) METHODS, APPARATUSES, AND COMPUTER PROGRAM PRODUCTS FOR ENHANCING LOCAL BREAKOUT SESSIONS IN ROAMING SCENARIOS

(71) Applicant: NOKIA TECHNOLOGIES OY, Espoo (FI)

(72) Inventors: Tezcan COGALAN, London (GB); Shubhranshu SINGH, Seeheim (DE); Laurent THIÉBAUT, Antony (FR)

(21) Appl. No.: 18/934,981

(22) Filed: Nov. 1, 2024

Related U.S. Application Data
(60) Provisional application No. 63/596,114, filed on Nov. 3, 2023.

(51) Int. Cl. H04W 48/18; H04W 48/16; H04W 84/04

(52) U.S. Cl. CPC H04W 48/18; H04W 48/16; H04W 84/042

(57) ABSTRACT

A method, apparatus and computer program product are provided for enhancing local breakout sessions in roaming scenarios. In the context of a method, the method includes receiving a request comprising an information, where the information comprises at least one of: an application function (AF) identifier associated with a user equipment (UE) that is associated with an existing home routed-session breakout (HR-SBO) packet data unit (PDU) session; or an internet protocol (IP) address of the UE that is associated with the existing HR-SBO session. The method further includes determining, based on the information, a data network name (DNN) and single network slice selection assistance information (S-NSSAI) of the existing HR-SBO PDU session associated with the UE. The method further includes sending, in a response to the request, the determined DNN and the S-NSSAI.

### CROSS REFERENCE TO RELATED APPLICATIONS

This application claims the benefit of U.S. Provisional Application No. 63/596,114, filed Nov. 3, 2023, the entire contents of which are incorporated herein by reference.

### TECHNICAL FIELD

An example embodiment relates generally to new calling techniques for i) enabling a network exposure function (NEF) in a visited public land mobile network (VPLMN) to determine the domain network name (DNN) and single network slice selection assistance information (S-NSSAI) of a home-routed session breakout (HR-SBO) protocol data unit (PDU) session, and ii) enabling a mobile network (e.g., a fifth generation core (5GC), and/or the like) to provide information of the DNN and S-NSSAI of an HR-SBO PDU session to an application function (AF).

### BACKGROUND

Legacy approaches to determining the DNN and S-NSSAI of an HR-SBO PDU session may rely upon a local configuration derived from the roaming agreements between two operators, home PLMN (HPLMN) and VPLMN. For example, a visited network exposure function (V-NEF) may determine, the HPLMN identifier (ID) of a user equipment (UE) and the DNN/S-NSSAI of the HR-SBO PDU session based on a local configuration (e.g., where the UE internet protocol (IP) address is a private IP address). As another example, where the UE IP address is assumed to be a public IP address based on HR-SBO roaming agreements, the V-NEF may determine the HPLMN ID of the UE and the DNN/S-NSSAI based on a configured public IP address range. Such approaches may be impractical due i) the existing DNN/S-NSSAI configurations changing more frequently compared to the roaming agreements between operators, and ii) increased probability of errors and mistakes due to operator syncing requirements for any configuration update (especially considered that one operator may have roaming agreements with hundreds of other operators).

### BRIEF SUMMARY

A method, apparatus and computer program product are provided in accordance with an example embodiment in order to i) enable a V-NEF to determine the DNN and S-NSSAI of an HR-SBO PDU session, and ii) enabling a mobile network to provide information of the DNN and S-NSSAI of an HR-SBO PDU session to an application function (AF). In various embodiments, the present method, apparatus, and computer program product provide improved solutions for enabling a V-NEF to retrieve and/or store information in a unified data repository (UDR). Various embodiments also provide improved techniques for enabling an AF to influence an HR-SBO traffic in the VPLMN. In various embodiments, the disclosed techniques overcome challenges associated with existing configuration-based solutions by accommodating the dynamicity that is associated with the deployment of edge application servers (EASs) and establishment of DNNs and S-NSSAI and respective AF requests.

In some embodiments, based on a V-NEF determining that a PDU session is HR-SBO and identifies the HPLMN identifier associated with the UE, the V-NEF contacts the NEF of the HPLMN (e.g., H-NEF) with an AF identifier and UE IP address to obtain the corresponding DNN and S-NSSAI of the existing HR-SBO PDU session from the HPLMN. In some embodiments, the enhanced functionality of the NEF is embodied as an invokable service (e.g., Nnef_DNN_Slice), which may be called by NEFs, AFs, and/or the like. For example, a second service may be used by an AF towards a H-NEF when the AF subscribes to and obtains a notification on serving PLMN change from the home session management function (H-SMF) (e.g., following a V-SMF insertion or inter-PLMN V-SMF change). In such instances, an AF identifier and UE identifier (e.g., UE IP address, GPSI, external identifier, and/or the like) are used as the input parameters of the service.

In at least one embodiment, a method is provided that includes receiving a request (812) comprising information, wherein the information comprises at least one of the following: an application function (AF) identifier associated with a user equipment (UE) that is associated with an existing home routed-session breakout (HR-SBO) packet data unit (PDU) session; or an internet protocol (IP) address of the UE that is associated with the existing HR-SBO session; determining (815), based on the information, a data network name (DNN) and single network slice selection assistance information (S-NSSAI) of the existing HR-SBO PDU session associated with the UE; and sending (818) in a response to the request, the determined DNN and the S-NSSAI. In some embodiments, the request is received from a visited network exposure function (V-NEF) and the request comprises the AF identifier and the IP address of the UE associated with the existing HR-SBO PDU session.

In at least one embodiment, a method is provided that includes As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to receive a request (812) comprising information, wherein the information comprises at least one of the following: an application function (AF) identifier associated with a user equipment (UE) that is associated with an existing home routed-session breakout (HR-SBO) packet data unit (PDU) session; or an internet protocol (IP) address of the UE that is associated with the existing HR-SBO session; determine (815), based on the information, a data network name (DNN) and single network slice selection assistance information (S-NSSAI) of the existing HR-SBO PDU session associated with the UE; and send (818) in a response to the request, the determined DNN and the S-NSSAI. In the same example, the apparatus may also perform other operations and/or embody additional aspects of the above-described methods.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to receive a request (812) comprising information, wherein the information comprises at least one of the following: an application function (AF) identifier associated with a user equipment (UE) that is associated with an existing home routed-session breakout (HR-SBO) packet data unit (PDU) session; or an internet protocol (IP) address of the UE that is associated with the existing HR-SBO session; determine (815), based on the information, a data network name (DNN) and single network slice selection assistance information (S-NSSAI) of the existing HR-SBO PDU session associated with the UE; and send (818) in a response to the request, the determined DNN and the S-NSSAI. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include means for means for receiving a request (812) comprising information, wherein the information comprises at least one of the following: an application function (AF) identifier associated with a user equipment (UE) that is associated with an existing home routed-session breakout (HR-SBO) packet data unit (PDU) session; or an internet protocol (IP) address of the UE that is associated with the existing HR-SBO session; means for determining (815), based on the information, a data network name (DNN) and single network slice selection assistance information (S-NSSAI) of the existing HR-SBO PDU session associated with the UE; and means for sending (818) in a response to the request, the determined DNN and the S-NSSAI. In the same example, the apparatus may embody additional aspects and/or include additional means for performing additional operations of the above-described methods.

determining (806) that a user equipment (UE) is associated with an existing home routed-session breakout (HR-SBO) packet data unit (PDU) session; sending (809) a request for a data network name (DNN) and single network slice selection assistance information (S-NSSAI) of the existing HR-SBO PDU session to a home-network exposure function (H-NEF), the request comprising information, wherein the information comprises at least one of the following: an application function (AF) identifier associated with the UE associated with the existing HR-SBO PDU session; or an internet protocol (IP) address of the UE associated with the existing HR-SBO PDU session; and receiving (821), from the H-NEF, a response comprising the DNN and the S-NSSAI. In some embodiments, the method further includes, based on the receiving the DNN and the S-NSSAI of the home public land mobile network (HPLMN), performing at least one of storing, updating, or deleting information at a visited unified data repository (V-UDR) based on the DNN and the S-NSSAI (824) of the HPLMN.

As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to determine (806) that a user equipment (UE) is associated with an existing home routed-session breakout (HR-SBO) packet data unit (PDU) session; send (809) a request for a data network name (DNN) and single network slice selection assistance information (S-NSSAI) of the existing HR-SBO PDU session to a home-network exposure function (H-NEF), the request comprising information, wherein the information comprises at least one of the following: an application function (AF) identifier associated with the UE associated with the existing HR-SBO PDU session; or an internet protocol (IP) address of the UE associated with the existing HR-SBO PDU session; and receive (821), from the H-NEF, a response comprising the DNN and the S-NSSAI. In the same example, the apparatus may also perform other operations and/or embody additional aspects of the above-described methods.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to determine (806) that a user equipment (UE) is associated with an existing home routed-session breakout (HR-SBO) packet data unit (PDU) session; send (809) a request for a data network name (DNN) and single network slice selection assistance information (S-NSSAI) of the existing HR-SBO PDU session to a home-network exposure function (H-NEF), the request comprising information, wherein the information comprises at least one of the following: an application function (AF) identifier associated with the UE associated with the existing HR-SBO PDU session; or an internet protocol (IP) address of the UE associated with the existing HR-SBO PDU session; and receive (821), from the H-NEF, a response comprising the DNN and the S-NSSAI. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include means for determining (806) that a user equipment (UE) is associated with an existing home routed-session breakout (HR-SBO) packet data unit (PDU) session; means for sending (809) a request for a data network name (DNN) and single network slice selection assistance information (S-NSSAI) of the existing HR-SBO PDU session to a home-network exposure function (H-NEF), the request comprising information, wherein the information comprises at least one of the following: an application function (AF) identifier associated with the UE associated with the existing HR-SBO PDU session; or an internet protocol (IP) address of the UE associated with the existing HR-SBO PDU session; and means for receiving (821), from the H-NEF, a response comprising the DNN and the S-NSSAI. In the same example, the apparatus may embody additional aspects and/or include additional means for performing additional operations of the above-described methods.

In at least one embodiment, a method is provided that includes sending a request (906) for a home public land mobile network (HPLMN) data network name (DNN) and single network slice selection assistance information (S-NSSAI) of an existing home routed-session breakout (HR-SBO) packet data unit (PDU) session to a home-NEF (H-NEF), the request comprising an IP address of a UE, wherein the UE is associated with the existing HR-SBO PDU session; receiving (912), from the H-NEF, the HPLMN DNN and the S-NSSAI associated with at least one of the following: application function (AF) information or UE information comprising the IP address of the UE associated with the existing HR-SBO PDU session; generating (800) a request to influence traffic for the UE associated with the existing HR-SBO PDU session, wherein the request comprises the HPLMN DNN and the S-NSSAI; and sending (800) the request to influence traffic for the UE associated with the existing HR-SBO PDU session to a visited-NEF (V-NEF) to cause the V-NEF to influence traffic forwarding in a network currently serving the existing HR-SBO PDU session. In some embodiments, the request further comprises a generic public subscription identifier (GPSI) for the UE associated with the existing HR-SBO PDU session. In some embodiments, the request further comprises an external identifier for the UE associated with the existing HR-SBO PDU session. In some embodiments, the method further comprises sending the request for the HPLMN DNN and the S-NSSAI based on: receiving a notification indicative of a serving public land mobile network (PLMN) change where HR-SBO is possible (1000).

In at least one embodiment, a method is provided that includes receiving (803) from an application function (AF) a request to influence traffic for a user equipment (UE) associated with an existing home routed-session breakout (HR-SBO) packet data unit (PDU) session, wherein the request comprises a data network name (DNN) and single network slice selection assistance information (S-NSSAI) of a home public land mobile network (HPLMN) for the existing HR-SBO PDU session; and based on the request, determining that the UE is associated with the existing HR-SBO PDU session (806). In some embodiments, the method further includes performing at least one of storing, updating, or deleting information at a visited unified data repository (V-UDR) based on the determining that the UE is associated with the existing HR-SBO PDU session (824). In some embodiments, the information at the V-UDR comprises one or more information provided by the AF, wherein the one or more information comprises the DNN and the S-NSSAI of the HPLMN.

In some embodiments, a method is provided that includes receiving (1006) a data network name (DNN) and single network slice selection assistance information (S-NSSAI) of a home public land mobile network (HPLMN) associated with an existing home routed-session breakout (HR-SBO) packet data unit (PDU) session; and sending a request to influence traffic for a user equipment (UE) associated with the existing HR-SBO PDU session, wherein the request comprises the DNN and the S-NSSAI of the HPLMN for the existing HR-SBO PDU session (1009). In some embodiments, the receiving of the DNN and the S-NSSAI of the HPLMN associated with the existing HR-SBO PDU session is preceded by: sending a subscription request to a home session management function (H-SMF) to subscribe to a change of a serving public land mobile network (PLMN) (1003); and the receiving the DNN and the S-NSSAI of the HPLMN associated with the existing HR-SBO PDU session comprises: receiving from the H-SMF a notification of the change of the serving PLMN during occurrence of said change, wherein the notification comprises the DNN and the S-NSSAI of the HPLMN associated with the existing HR-SBO PDU session (1006). In some embodiments, the step of sending the subscription request to the H-SMF is performed by an application function (AF) using a home network exposure function (H-NEF) as an intermediary. In some embodiments, the DNN and the S-NSSAI of the HPLMN associated with the existing HR-SBO PDU session is received as a response to a request to influence traffic routing on the PDU session.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 shows an architecture of an example fifth generation system (5GS) providing access to an edge application server (EAS) with an uplink classifier (UL CL) and branching point (BP) for a local breakout (LBO) roaming scenario.

FIG. 2 shows an architecture of an example 5GS providing access to an EAS with UL CL/BP for a home-routed session breakout (HR-SBO) roaming scenario.

FIG. 3 illustrates an example of a communication network in which an example embodiment of the present disclosure may be implemented;

FIG. 4 illustrates a block diagram of an apparatus that may be configured in accordance with an example embodiment of the present disclosure;

FIG. 5 illustrates a call flow diagram for an application function (AF) requesting an individual user equipment (UE) associated with an HR-SBO protocol data unit (PDU) session in accordance with an example embodiment of the present disclosure;

FIG. 6 illustrates a call flow diagram for an AF requesting a domain network name (DNN) and single network slice selection assistance information (S-NSSAI) from a home network exposure function (H-NEF) and sending a traffic influence request in accordance with an example embodiment of the present disclosure;

FIG. 7 illustrates a call flow diagram for serving a PLMN change notification with a DNN and S-NSSAI in accordance with an example embodiment of the present disclosure;

FIG. 8 illustrates an example flowchart of a process for providing a DNN and S-NSSAI to a V-NEF in accordance with an example embodiment of the present disclosure;

FIG. 9 illustrates an example flowchart of a process for providing a DNN and S-NSSAI to an AF in accordance with an example embodiment of the present disclosure; and

FIG. 10 illustrates an example flowchart of a process for providing to an AF a notification of serving PLMN change during said event and including a DNN and S-NSSAI in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with the described embodiments. Thus, use of any such terms should not be taken to limit the spirit and scope of the embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to signal, non-transitory computer-readable medium and the like. The term ‘non-transitory computer-readable medium’ refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

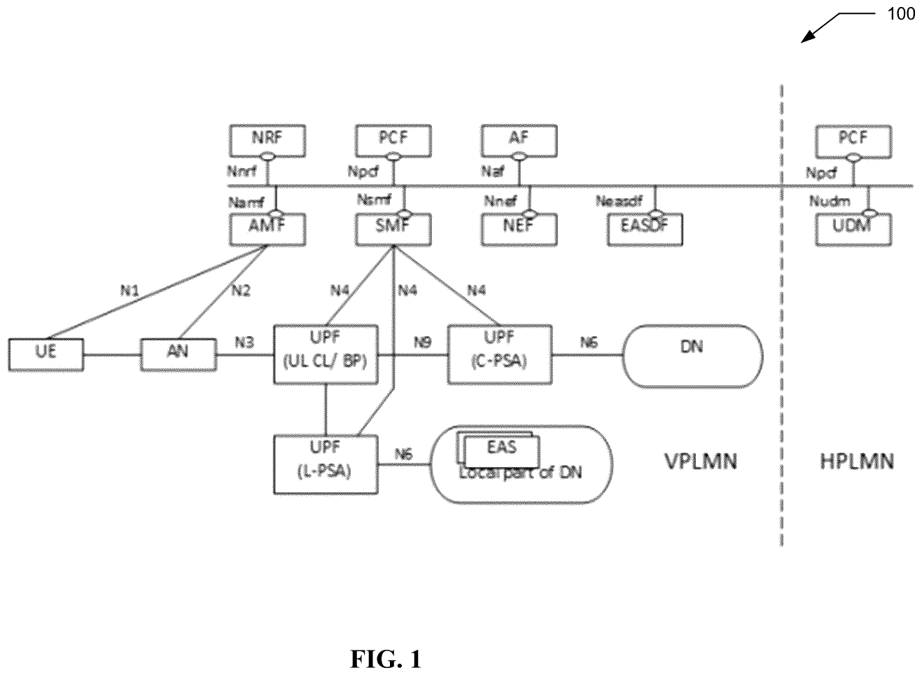

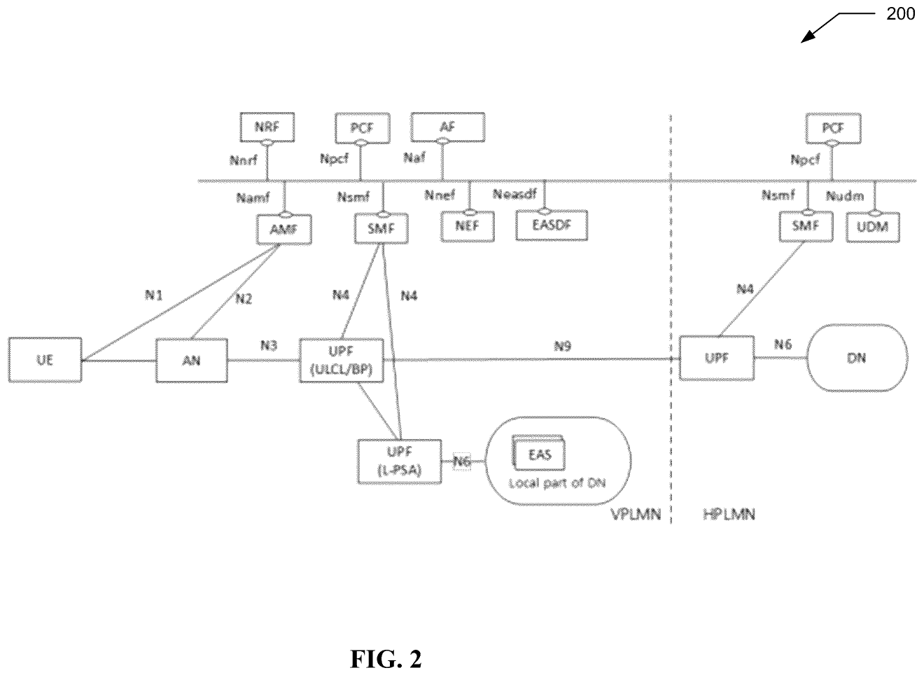

FIG. 1 shows an architecture of an example fifth generation system (5GS) 100 providing access to an edge application server (EAS) with an uplink classifier (UL CL) and branching point (BP) for a local breakout (LBO) roaming scenario. FIG. 2 shows an architecture of an example 5GS 200 providing access to an EAS with UL CL/BP for a home-routed session breakout (HR-SBO) roaming scenario. In some embodiments, the 5GS 200 enables a roaming user equipment (UE) to access an edge hosting environment (EHE) residing in a visiting public land mobile network (VPLMN) via a home routed protocol data unit (HR PDU) session. In some embodiments, this extended roaming architecture is referred to as HR-SBO and enables UE to access an EHE in VPLMN and also the data network (DN) in home PLMN (HPLMN).

In various embodiments, a difference between the LBO roaming architecture of the 5GS 100 and the HR-SBO architecture of the 5GS 200 is that, in LBO, a roaming UE is only able to access a local (part of a) DN and an EAS in a VPLMN. In contrast, in HR-SBO, a roaming UE may access a local (part of a) DN in a VPLMN and a central (part of a) DN in an HPLMN. Additional aspects of LBO and HR-SBO are described in Technical Specification (TS) 23.548, the disclosure of which is incorporated herein by reference in its entirety. In some embodiments, in the 5GS 200, an application function (AF) may send requests to influence traffic routing decisions for user plane traffic. In some embodiments, the AF request may influence the user plane function (UPF) selection and/or reselection and allow routing of user traffic to a local (part of a) DN or EAS. In some contexts, the AF requests may target an individual UE or a group of UEs. Additional procedures and aspects of AF influence on traffic routing are described in TS 23.548 and in TS 23.501 and TS 23.502, the disclosures of which are incorporated herein by reference in their entireties.

In various embodiments, when an AF belonging to a VPLMN sends a request to a visited network exposure function (V-NEF) (e.g., a NEF at a VPLMN) to influence the traffic of an individual UE that has an HR-SBO session, the traffic influence information is not sent a visited policy control function (V-PCF). Instead, i) the AF request may be stored at a visited unified data repository (V-UDR) (e.g., a UDR at a VPLMN), ii) and a visited session management function (V-SMF) (e.g., an SMF at a VPLMN) selected for the roaming UE may subscribe to any changes on the information stored at the V-UDR.

In various embodiments, for the V-NEF to understand whether the AF targeting an individual UE has an HR-SBO session or not, the V-NEF may determine the HPLMN of the targeted UE and a data network name (DNN) and single network slice selection assistance information (S-NSSAI) of the PDU session. In typical approaches, if i) the AF has not provided the HPLMN identifier (ID), DNN, and S-NSSAI in the traffic influence request and ii) the UE internet protocol (IP) address in the AF request is a private IP address, the V-NEF determines the HPLMN of the UE and the DNN/S-NSSAI of the PDU session based on a local configuration. In case the IP address of the UE in the AF request is a public IP address (e.g., according to an assumption that the V-NEF is configured with the association of public IP address ranges with an HPLMN ID, a DNN/S-NSSAI based on HR-SBO roaming agreements for the DNN/S-NSSAI), the V-NEF determines the HPLMN ID of the UE and the DNN/S-NSSAI of the PDU session based on the configured public IP address range. The public IP address range may be used to identify the HPLMN ID. However, the public IP address range may be impractical for this purpose because existing DNN/S-NSSAI configurations may change more frequently compared to the roaming agreements between operators. Additionally, the configuration-based approaches may be more prone to errors and mistakes, especially in the case of roaming scenarios as both operators should sync on any configuration update.

As further shown in the proceeding figures and described herein, certain embodiments of the present disclosure provide techniques for enabling a NEF in a VPLMN (e.g., V-NEF) to determine the DNN and S-NSSAI of an HR-SBO PDU session. In doing so, the present techniques may enable the NEF to retrieve and/or store respective information in a corresponding V-UDR. Additionally, various embodiments of the present disclosure provide techniques for providing information indicative of the DNN and S-NSSAI of the HR-SBO PDU session to an AF to enable the AF to influence traffic for the HR-SBO PDU session in the associated VPLMN.

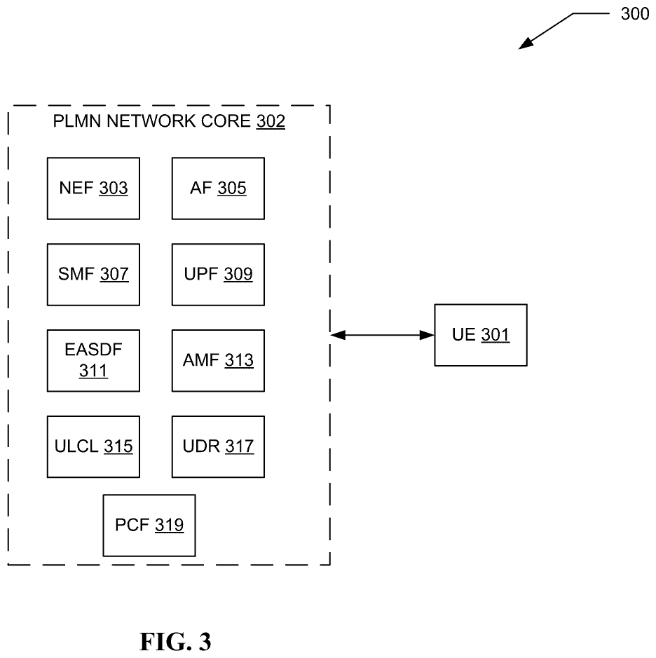

As illustrated in FIG. 3, a communication network 300 is provided in accordance with various embodiments of the present disclosure. In some embodiments, the communication network 300 includes one or more UEs 301 and a public land mobile network (PLMN) network core 302. The communication network 300 may include multiple PLMN network cores 302. For example, the communication network 300 may include a home PLMN (HPLMN) and a visited PLMN (VPLMN).

The UE 110 may be any type of user terminal, terminal device, etc. to which resources on the air interface are allocated and assigned. For example, the UE may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The user equipment may also be called a subscriber unit, mobile station, remote terminal, access terminal, user terminal or user equipment (UE) just to mention but a few names or apparatuses.

In some embodiments, the PLMN network core 302 includes a plurality of network elements. Alternatively, or additionally, in some embodiments, one or more of the network clements are external to the PLMN network core 302. In some embodiments, the network elements include a network exposure function (NEF) 303, application function (AF) 305, session management function (SMF) 307, user plane function (UPF) 309, edge application server discovery function (EASDF) 311, access and mobility management function (AMF) 313, uplink classifier function (ULCL) 315, unified data repository (UDR) 317, and policy control function (PCF) 319.

In some embodiments, the NEF 303 exposes network functions capabilities system to external network functions such as third-party application functions and other external network environments (e.g., including other PLMNs). In some embodiments, the AF 305 is a control plane function that provides application services to the UE 301. In some embodiments, the SMF 307 manages session establishment, modification, and deletion. In some embodiments, the SMF 307 manages and allocates internet protocol (IP) addresses for UEs 301. In some embodiments, the SMF 307 manages downlink data notifications and other notifications described herein.

In some embodiments, the UPF 309 routes and forwards user plane packets and performs downlink packet buffering and downlink data notification triggering. In some embodiments, the EASDF 311 supports the UE 301 in discovering nearest edge application servers (EASs). In some embodiments, the AMF 313 performs registration management, connection management, reachability management, mobility management, and access authentication and authorization. In some embodiments, the ULCL 315 routes and diverts user equipment traffic to local data networks based on one or more filters. In some embodiments, the UDR 317 stores and enables retrieval of data associated with various network elements (e.g., NEF 303, PCF 319, and/or the like) including subscription data, policy data, and other structured data. In some embodiments, the PCF 319 provides policy rules to the AMF 313 and other network elements for enforcement. In some embodiments, the PCF 319 accesses subscription data at the UDR 317 to support policy decisions.

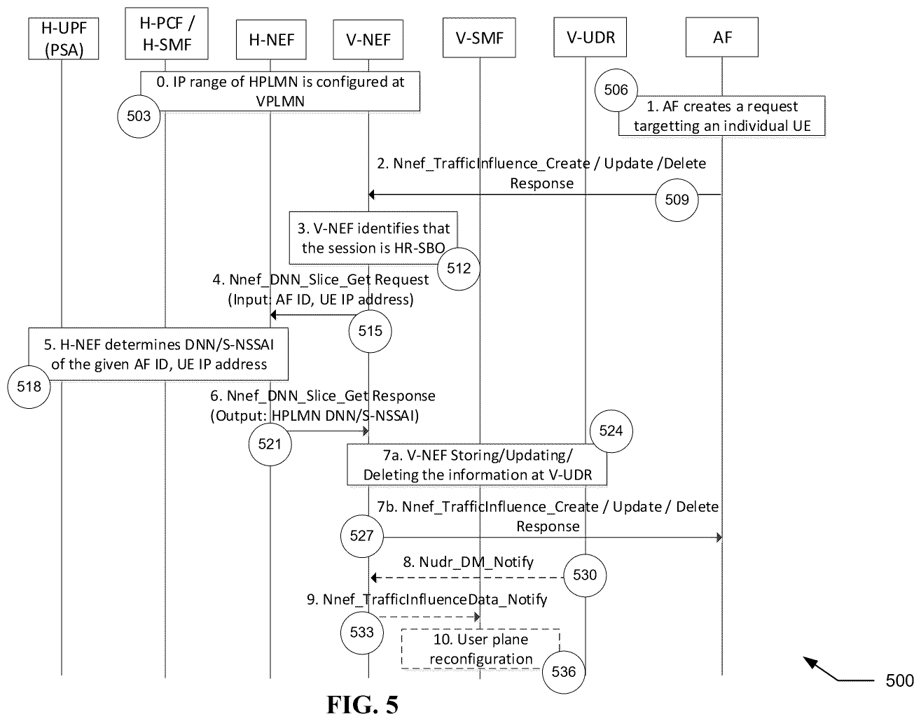

Additional aspects and functions of the network elements are described herein in reference to the various call flows and processes shown in FIGS. 5-10.

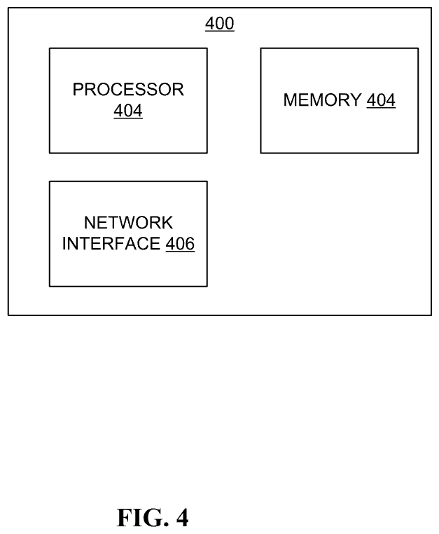

FIG. 4 shows an example apparatus 400 according to one embodiment. Any of the home network exposure function (H-NEF), visited (V-NEF), visited session management function (V-SMF), application function (AF), home user plane function (H-UPF), home policy control function (H-PCF), home SMF, and/or the like, referenced herein may embody the apparatus 400. For example, the H-NEF, V-NEF, and AF may cach embody a different apparatus 400 that is configured to perform the corresponding functions of that network element described herein.

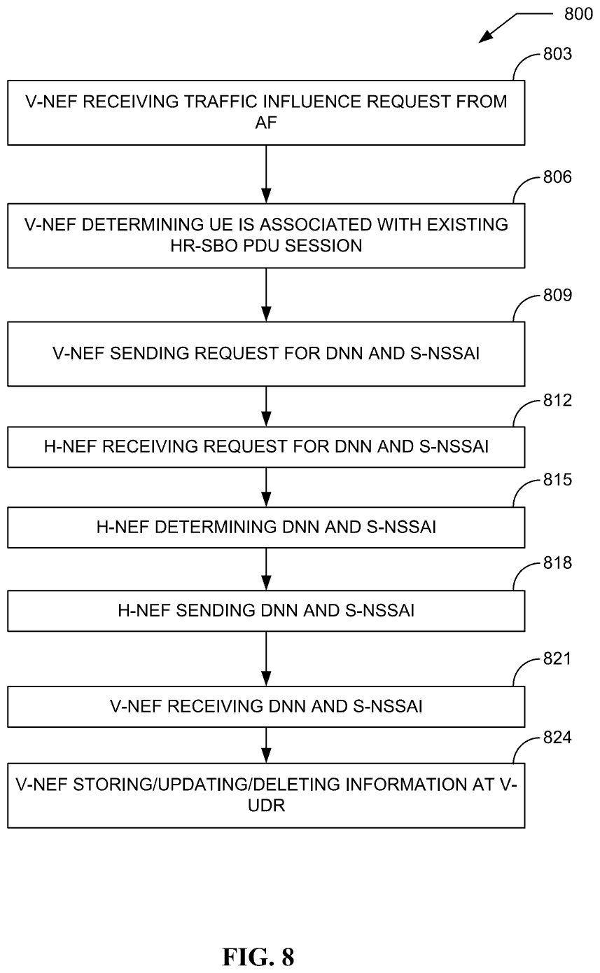

Regardless of the device that embodies the apparatus 400, the apparatus may include processor 402, memory 404, and network interface 406. The apparatus 400 may be configured to execute the operations described herein. For example, a plurality of apparatuses 400 embodied as different network elements may be configured to perform the call flows shown in FIGS. 5-7 and the processes shown in FIGS. 8-10.

Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 402 (and/or co-processor or any other processing circuitry assisting or otherwise associated with the processor) may be in communication with the memory 404 via a bus for passing information among components of the apparatus. The memory 404 is non-transitory and may include, for example, one or more volatile and/or non-volatile memories. In other words, for example, the memory 404 may be an electronic storage device (e.g., a non-transitory computer-readable storage medium). The memory 404 may be configured to store information, data, content, applications, instructions, or the like for enabling the apparatus to carry out various functions in accordance with an example embodiment disclosed herein. In some embodiments, the memory 404 embodies a visited unified data repository (V-UDR).

The processor 402 may be embodied in a number of different ways and may, for example, include one or more processing devices configured to perform independently. In some non-limiting embodiments, the processor 402 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 402 may be configured to execute instructions stored in the memory 404 and/or circuitry otherwise accessible to the processor 402. In some embodiments, the processor 402 may be configured to execute hard-coded functionalities. As such, whether configured by hardware or software methods, or by a combination thereof, the processor 402 may represent an entity (e.g., physically embodied in circuitry) capable of performing operations according to an embodiment disclosed herein while configured accordingly. Alternatively, as another example, when the processor 402 is embodied as an executor of software instructions, the instructions may specifically configure the processor 402 to perform the algorithms and/or operations described herein when the instructions are executed.

In some embodiments, the apparatus 400 may optionally include input/output circuitry that may, in turn, be in communication with processor 402 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 404, and/or the like).

The network interface 406 may be any means such as a device or circuitry embodied in either hardware or a combination of hardware and software that is configured to receive and/or transmit data from/to a network and/or any other device, circuitry, or module in communication with the apparatus 400. In this regard, the network interface 406 may include, for example, a network interface for enabling communications with a wired or wireless communication network, such as the application function (AF), multicast and broadcast service function (MBSF), multicast and broadcast user plane function (MB-UPF), and/or multicast and broadcast session management function (MB-SMF). For example, the network interface 406 may include one or more network interface cards, antennac, buses, switches, routers, modems, and supporting hardware and/or software, or any other device suitable for enabling communications via a network. Additionally, or alternatively, the network interface 406 may include the circuitry for interacting with the antenna/antennac to cause transmission of signals via the antenna/antennac or to handle receipt of signals received via the antenna/antennac.

FIG. 5 illustrates a call flow diagram 500 for an application function (AF) requesting an individual user equipment (UE) associated with a home routed-session breakout (HR-SBO) protocol data unit (PDU) session in accordance with an example embodiment of the present disclosure. In some embodiments, the call flow enables a serving public land mobile network (PLMN) network exposure function (NEF) (e.g., a visitor NEF (V-NEF)) to retrieve a domain network name (DNN) and single network slice selection assistance information (S-NSSAI) of the PDU session from the home PLMN (HPLMN). In some embodiments, when an AF requests a traffic influence targeting an individual UE, the V-NEF determines whether the session is HR-SBO or not based on a local configuration on IP range of the HPLMN. In some embodiments, based on IP range of the HPLMN, the V-NEF determines the UE HPLMN identifier (ID) and invokes a service (e.g., Nnef_DNN_Slice_Get) with the UE IP address and an AF identifier to send a request for a DNN and S-NSSAI to a home NEF (H-NEF). In some embodiments, the H- NEF uses the AF identifier to contact a network repository function (NRF) for a particular AF identifier, where the DNN and S-NSSAI may be known or configured in the HPLMN respective to the AF identifier. In some embodiments, the H-NEF responds to the V-NEF with the DNN and S-NSSAI associated with the HR-SBO PDU.

In some embodiments, as part of the roaming agreement between the HPLMN and VPLMN, the IP range of the HPLMN is available at the VPLMN (see indicium 503). In some embodiments, the V-SMF supporting HR-SBO subscribes to notifications of AF request by invoking a service from the V-NEF (e.g., Nnef_TrafficInfluenceData_Subscribe). In some embodiments, the same initialization is performed in the call flow shown in FIG. 5.

In some embodiments, the AF generates a traffic influence request targeting an individual UE (see indicium 506). In some embodiments, the AF sends the traffic influence request including the UE public IP address to a V-NEF (see indicium 509). In some embodiments, based on the IP range of the HPLMN, the V-NEF determines that the UE is associated with an existing HR-SBO PDU session (see indicium 512). In some embodiments, the V-NEF provides a request to retrieve a DNN and S-NSSAI of the HR-SBO PDU session at the HPLMN to the H-NEF, where the request may include the UE public IP address and/or an AF identifier as the input (see indicium 515). In some embodiments, to send the request, the V-NEF may invoke a service at the H-NEF with the input (e.g., Nnef_DNN_Slice_Get).

In some embodiments, the H-NEF obtains the DNN and S-NSSAI of the HR-SBO PDU session at the HPLMN for the given UE public IP address and/or AF identifier (see indicium 518). In some embodiments, the H-NEF invokes a service (e.g., Nnef_DNN_Slice_Get Response) to send the HPLMN DNN and S-NSSAI-related information to the V-NEF (sce indicium 521). In some embodiments, the V-NEF stores, updates, and/or deletes information at a visited unified data repository (V-UDR) based on the HPLMN DNN and S-NSSAI-related information (see indicium 524). In some embodiments, based on the actions performed by the V-NEF respective to the V-UDR, the V-NEF sends to the AF a response to the request (e.g., Nnef_TrafficInfluence_Create/Update/Delete) (see indicium 527). In some embodiments, the V-UDR notifies the subscribed V-NEF of the AF traffic influence request information (see indicium 530). In some embodiments, the V-NEF notifies the subscribed V-SMF of the AF traffic influence request information (see indicium 533). In some embodiments, when the V-SMF receives the notification from the V-NEF, the V-SMF may take appropriate actions to reconfigure the user plane of the PDU Session.

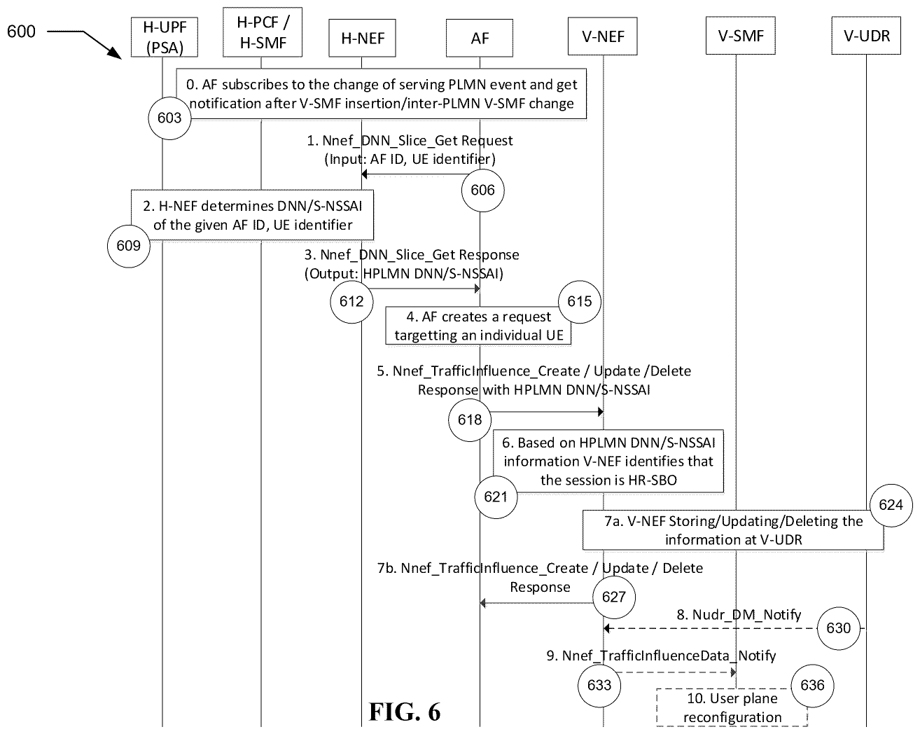

FIG. 6 illustrates a call flow diagram for an AF requesting a domain network name (DNN) and single network slice selection assistance information (S-NSSAI) from a home network exposure function (H-NEF) and sending a traffic influence request in accordance with an example embodiment of the present disclosure. In some embodiments, the call flow enables the AF to retrieve domain network name (DNN) and single network slice selection assistance information (S-NSSAI) information from a home network exposure function (H-NEF) during or after the serving of a public land mobile network (PLMN) change notification.

In some embodiments, e.g. when the AF receives a serving PLMN change notification, the AF requests home PLMN (HPLMN) DNN and S-NSSAI information from an H-NEF by invoking a service with UE information (e.g., a UE internet protocol (IP) address, generic public subscription identifier (GPSI) that may take the form of an external identifier, and/or the like). In some embodiments, the external identifier includes a domain identifier and a local identifier for the UE. In some embodiments, the H-NEF responds by sending, to the AF, the HPLMN DNN and S-NSSAI associated with the UE. In some embodiments, when the AF requests a traffic influence targeting the UE in a visited PLMN (VPLMN), the AF provides the HPLMN DNN/S-NSSAI to a visited NEF (V-NEF).

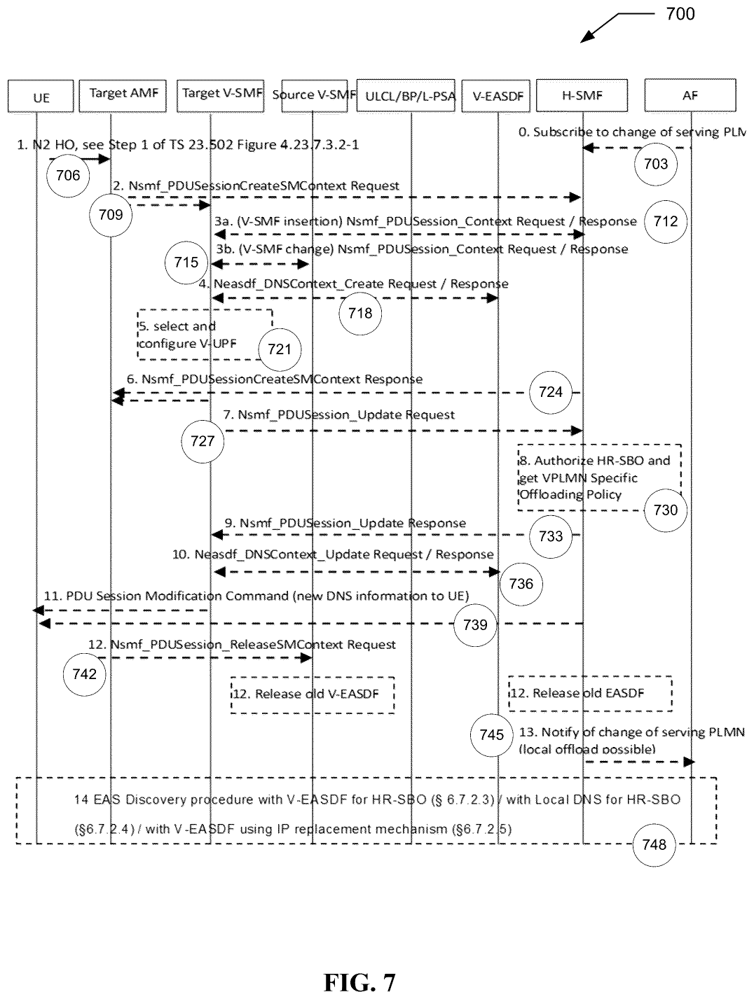

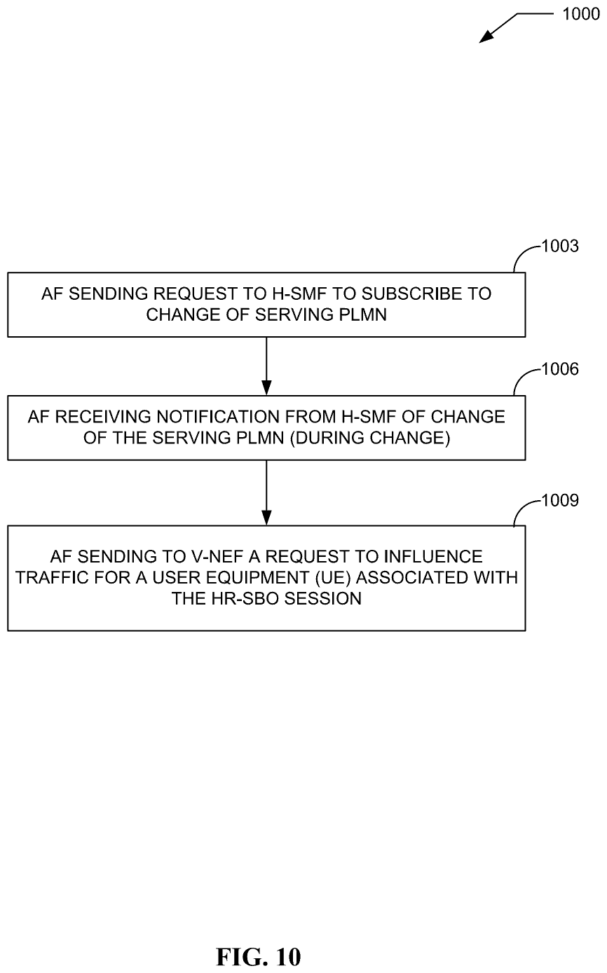

In some embodiments, the AF subscribes onto a home session management function (H-SMF) for the event related with a mobility of a protocol data unit (PDU) session towards a serving PLMN where local traffic offload is possible (see indicium 603). In some embodiments, the possibility of local traffic offload refers to mobility of the PDU session towards a visited PLMN (VPLMN) where HR-SBO is supported and allowed. In some embodiments, the possibility of local traffic offload refers to mobility of the PDU session back to the HPLMN. In some embodiments, once a visitor SMF (V-SMF) insertion or inter-PLMN V-SMF change has completed, the H-SMF sends a notification regarding the change of serving PLMN to the AF (see also FIGS. 7 and 10).

In some embodiments, once the AF receives the serving PLMN change with local offload possible notification, the AF invokes a service request (e.g., Nnef_DNN_Slice_Get) to the H-NEF with additional information (see indicium 606). In some embodiments, the additional information includes an AF Identifier and a UE identifier. In some embodiments, the UE identifier embodies a UE IP address, GPSI, possibly taking the form of an external identifier or any other identifier that can be used to identify UE to retrieve the DNN/S-NSSAI of the PDU session at home PLMN (HPLMN). In some embodiments, the H-NEF obtains DNN/S-NSSAI of the PDU session at HPLMN for the given UE identifier and AF Identifier (see indicium 609). In some embodiments, the H-NEF requests and receives data from a user plane function (UPF), where the data includes the DNN and S-NSSAI of the PDU session and the non-network address translated (non-NATed) IP address of the UE (the IP address allocated to the UE for the PDU Session). In some embodiments, the H-NEF sends a response to the service request (e.g., Nnef_DNN_Slice_Get Response) with the HPLMN DNN/S-NSSAI information to the AF and possibly the non-network address translated (non-NATed) IP address of the UE (see indicium 612).

In some embodiments, the AF generates a traffic influence request targeting an individual UE (see indicium 615). In some embodiments, the AF sends the traffic influence request to a V-NEF, where the request includes the HPLMN DNN/S-NSSAI of the UE and possibly the non-network address translated (non-NATed) IP address of the UE (see indicium 618). In some embodiments, based on the provided HPLMN DNN/S-NSSAI provided in traffic influence request, the V-NEF determines that the UE is associated with an existing HR-SBO session (see indicium 621). In some embodiments, based on the determination, the V-NEF stores, updates, and/or deletes the information regarding the HR-SBO session (HPLMN ID, HPLMN DNN and HPLMN S-NSSAI) and possibly the non-network address translated (non-NATed) IP address of the UE at a visited unified data repository (V-UDR) (see indicium 624). In some embodiments, based on the actions performed by the V-NEF respective to the V-UDR, the V-NEF sends to the AF a response to the request (e.g., Nnef_TrafficInfluence_Create/Update/Delete) (see indicium 627).

In some embodiments, the V-UDR notifies the subscribed V-NEF (which may be different from the NEF having handled the AF request) of the AF traffic influence request information (see indicium 630). In some embodiments, the V-NEF notifies the subscribed V-SMF of the AF traffic influence request information (e.g., UE identifier or the non-network address translated (non-NATed) IP address of the UE, traffic forwarding rules and/or the like) (see indicium 633). In some embodiments, when the V-SMF receives the notification from the V-NEF, the V-SMF may take appropriate actions to reconfigure the user plane of the PDU session (see indicium 636).

FIG. 7 illustrates a call flow diagram for serving a PLMN change notification with DNN and S-NSSAI information in accordance with an example embodiment of the present disclosure. In some embodiments, the AF may subscribe onto a home session management function (H-SMF) for the event related with a mobility of the PDU session towards a serving PLMN where local traffic offload is possible (e.g., mobility of the PDU session either towards HPLMN or a VPLMN where HR-SBO is supported and allowed) (see indicum 703). In some embodiments, the AF calls for the subscription via a network exposure function (NEF) (e.g., home NEF, visited NEF, and/or the like) that acts as an intermediary between the H-SMF and AF.

In some embodiments, the calls associated with indicia 706-742 and 748 are performed as described in the incorporated TS 23.548. In some embodiments, if the AF has subscribed to serving PLMN change event towards a PLMN where local offload is possible for the PDU session (e.g., per indicium 703) and said change event occurs, the H-SMF sends a notification to the AF indicating the target serving PLMN identifier and/or DNN and S-NSSAI of the HPLMN and possibly the non-network address translated (non-NATed) IP address of the UE (see indicium 748). In some embodiments, the H-SMF sends the notification to the AF based on receiving an indication of handover completion. In some embodiments, the H-SMF sends the notification indicating the target serving PLMN identifier and/or DNN and S-NSSAI of the HPLMN and possibly the non-network address translated (non-NATed) IP address of the UE via the NEF that acts as an intermediary between the H-SMF and AF. In some embodiments, the notification includes an indication of HR-SBO and/or that local offload is possible. In some embodiments, the H-SMF detects the event (e.g., serving PLMN change) when an insertion and/or change of visited-SMF (V-SMF) and the handover from the HPLMN to a VPLMN (or from a first VPLMN to a second VPLMN) has completed.

In various embodiments, the call flows shown in FIGS. 5-6 enable a V-NEF or AF to retrieve HPLMN DNN and NSSAI information and possibly the non-network address translated (non-NATed) IP address of the UE associated with an existing HR-SBO PDU session during a serving PLMN change or otherwise. Additionally, the call flow of FIG. 7 enables the AF to receive a notification of serving PLMN change with DNN-and S-NSSAI-related information and possibly the non-network address translated (non-NATed) IP address of the UE for the HR-SBO PDU session during the serving PLMN change. In doing so, the techniques provided by the call flows may overcome technical challenges associated with providing non-configuration-based approaches to determining a DNN and S-NSSAI of a HR-SBO PDU session. For example, the described techniques may better accommodate the dynamicity of the deployment of edge application servers (EASs) and increased frequencies of DNN and NSSAI configurations (for example for associated IP address ranges) as compared to configuration-based approaches.

Referring now to FIG. 8., shown is a flowchart of a process 800 for providing a DNN and S-NSSAI to a V-NEF, which may be performed by a plurality of apparatuses 400 that embody different network elements including a V-NEF, H-NEF, V-UDR, and/or the like.

In some embodiments, at block 803, the apparatus embodying a V-NEF includes means, such as the processor 402, the memory 404, the network interface 406, or the like, for receiving a traffic influence request from an AF. In some embodiments, the traffic influence request includes an AF identifier, UE identifier, and/or the like. For example, the traffic influence request may include a public IP address, external identifier, GPSI, and/or the like of a UE. The UE may be associated with an existing HR-SBO PDU session.

In some embodiments, at block 806, the apparatus embodying the V-NEF includes means, such as the processor 402, the memory 404, the network interface 406, or the like, for determining the UE is associated with an existing HR-SBO PDU session. In some embodiments, the apparatus embodying the V-NEF determines the UE is associated with the existing HR-SBO PDU session based on the IP range of the HPLMN and the UE IP address from the traffic influence request.

In some embodiments, at block 809, the apparatus embodying the V-NEF includes means, such as the processor 402, the memory 404, the network interface 406, or the like, for sending a request for a DNN and S-NSSAI associated with the HR-SBO PDU session to an H-NEF. In some embodiments, the request contains the UE IP address and/or AF identifier from the traffic influence request. In some embodiments, to send the request, the apparatus embodying the V-NEF invokes a service at a second apparatus embodying the H-NEF (e.g., Nnef_DNN_Slice_Get). In some embodiments, at block 812, a second apparatus embodying the H-NEF includes means, such as the processor 402, the memory 404, the network interface 406, or the like, for receiving the request for the DNN and S-NSSAI of the HR-SBO PDU session. In some embodiments, at block 815, the apparatus embodying the H-NEF includes means, such as the processor 402, the memory 404, the network interface 406, or the like, for determining the DNN and S-NSSAI associated with the HR-SBO PDU session and possibly the non-network address translated (non-NATed) IP address of the UE. In some embodiments, at block 818, the second apparatus embodying the H-NEF includes means, such as the processor 402, the memory 404, the network interface 406, or the like, for sending a response to the V-NEF including DNN-and S-NSSAI-related information for the HR-SBO PDU session and possibly the non-network address translated (non-NATed) IP address of the UE. In some embodiments, the second apparatus embodying the H-NEF invokes a (e.g., Nnef_DNN_Slice_Get Response) to send the HPLMN DNN and S-NSSAI-related information and possibly the non-network address translated (non-NATed) IP address of the UE.

In some embodiments, at block 821, the apparatus embodying the V-NEF includes means, such as the processor 402, the memory 404, the network interface 406, or the like, for receiving the response from the H-NEF including the DNN and S-NSSAI and possibly the non-network address translated (non-NATed) IP address of the UE. In some embodiments, at block 824, the apparatus embodying the V-NEF includes means, such as the processor 402, the memory 404, the network interface 406, or the like, for storing, updating, and/or deleting information at a V-UDR based on the DNN-and S-NSSAI-related information and possibly the non-network address translated (non-NATed) IP address of the UE associated with the HR-SBO PDU session. In some embodiments, the apparatus embodying the V-NEF includes means, such as the processor 402, the memory 404, the network interface 406, or the like, for sending a response to the traffic influence request to the AF, where the response is based on the actions performed by the V-NEF respective to the V-UDR.

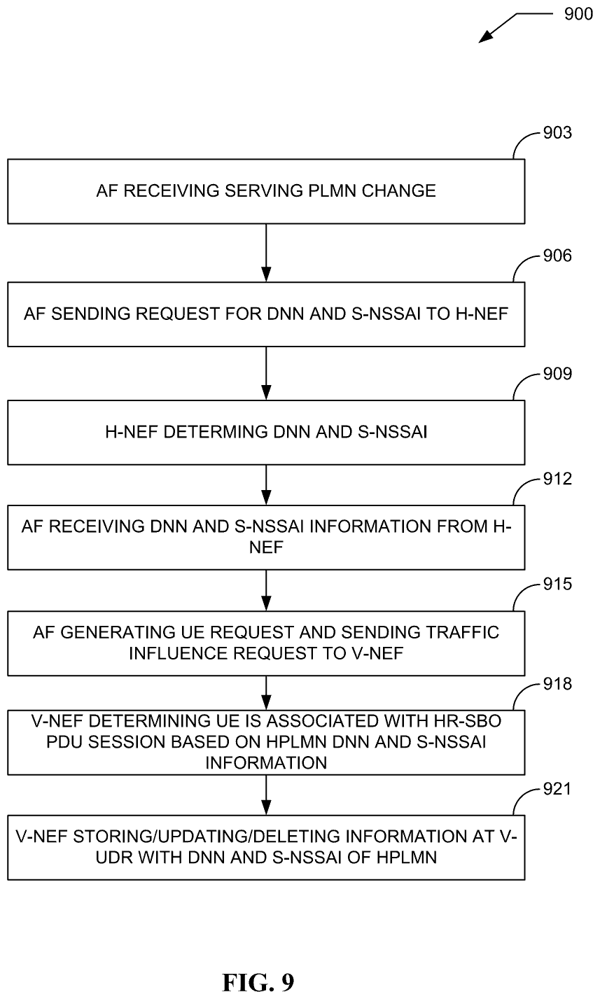

Referring now to FIG. 9, shown is an example flowchart of a process 900 for providing a DNN and S-NSSAI to an AF, which may be performed by a plurality of apparatuses 400 that embody different network elements including an AF, H-SMF, H-NEF, V-NEF, and/or the like. In some embodiments, at block 903, an apparatus embodying the AF includes means, such as the processor 402, the memory 404, the network interface 406, or the like, for receiving a notification of serving PLMN change. In some embodiments, the notification of serving PLMN change indicates whether local offload is possible. In some embodiments, at block 906, the apparatus embodying the AF includes means, such as the processor 402, the memory 404, the network interface 406, or the like, for sending a request for a DNN and S-NSSAI of the associated HR-SBO PDU session to an H-NEF. In some embodiments, the apparatus embodying the AF invokes a service request to the H-NEF (e.g., Nnef_DNN_Slice_Get) with input including a UE identifier (e.g., IP address, GPSI, e.g. under the form of an external identifier, and/or the like), AF identifier, and/or the like.

In some embodiments, at block 909, a second apparatus embodying the H-NEF includes means, such as the processor 402, the memory 404, the network interface 406, or the like, for determining DNN-and S-NSSAI-related information and possibly the non-network address translated (non-NATed) IP address of the UE for the HR-SBO PDU session based on the UE identifier, AF identifier, and/or the like. In some embodiments, at block 912, the apparatus embodying the AF includes means, such as the processor 402, the memory 404, the network interface 406, or the like, for receiving the DNN-and S-NSSAI-related information and possibly the non-network address translated (non-NATed) IP address of the UE from the H-NEF. In some embodiments, the second apparatus embodying the H-NEF invokes a service to send the response to the AF service request (e.g., Nnef_DNN_Slice_Get Response).

In some embodiments, at block 915, the apparatus embodying the AF includes means, such as the processor 402, the memory 404, the network interface 406, or the like, for generating a request to influence traffic targeting the UE and sending the traffic influence request to a third apparatus embodying a V-NEF. In some embodiments, the traffic influence request includes the DNN and S-NSSAI of the HPLMN. In some embodiments, the request includes the UE identifier, AF identifier, and/or the like. In some embodiments, at block 918, the apparatus embodying the V-NEF includes means, such as the processor 402, the memory 404, the network interface 406, or the like, for determining that the UE is associated with an HR-SBO PDU session based on the HPLMN DNN-and S-NSSAI-related information. In some embodiments, at block 921, the apparatus embodying the V-NEF includes means, such as the processor 402, the memory 404, the network interface 406, or the like, for storing, updating, and/or deleting information at a V-UDR based on the DNN-and S-NSSAI-related information associated with the HPLMN.

FIG. 10 illustrates an example flowchart of a process 1000 for providing to an AF a notification of serving PLMN change during said event and including a DNN and S-NSSAI. In some embodiments, the process 1000 is performed by a plurality of apparatuses 400 that embody different network clements including an AF, H-SMF, and/or the like. In some embodiments, at block 1003, the apparatus embodying an AF includes means, such as the processor 402, the memory 404, the network interface 406, or the like, for sending a request to an H-SMF to subscribe to a change of serving PLMN such that the AF may be notified if said event occurs. In some embodiments, the apparatus embodying the AF calls for the subscription via a NEF (e.g., H-NEF, V-NEF, and/or the like) that acts as an intermediary between the apparatus embodying the AF and a second apparatus embodying the H-SMF. In some embodiments, at block 1006, the apparatus embodying the AF includes means, such as the processor 402, the memory 404, the network interface 406, or the like, for receiving a notification of change of the serving PLMN from the H- SMF during the serving PLMN change, where the notification may include a DNN and S-NSSAI of the HR-SBO PDU session associated with the new PLMN (e.g., where local offload is possible).

In some embodiments, at block 1009, the apparatus embodying the AF includes means, such as the processor 402, the memory 404, the network interface 406, or the like, for generating and sending to an apparatus embodying a V-NEF a request to influence traffic for a user equipment (UE) associated with the existing HR-SBO PDU session. In some embodiments, the request includes the DNN and the S-NSSAI of the HPLMN associated with the existing HR-SBO PDU session. In some embodiments, the request includes a UE identifier associated with the UE, an identifier associated with the AF, and/or the like.

In various embodiments, the method, apparatus and computer program product of the present disclosure are provided for i) enabling a NEF in VPLMN (e.g., V-NEF) to determine the DNN and S-NSSAI of an existing HR-SBO PDU session and ii) enabling the sending of DNN- and S-NSSAI-related information for an HR-SBO PDU session to an AF (e.g., to enable the AF to influence HR-SBO traffic in the VPLMN). The described method, apparatus, and computer program product may overcome challenges of existing approaches to better support the dynamicity of EAS deployment and accommodate frequent changes in DNN and S-NSSAI configurations.

It will be understood that cach block of the flowcharts and combination of blocks in the flowcharts show in the figures and described herein may be implemented by various means, such as hardware, firmware, processor, circuitry, and/or communication devices associated with execution of software including one or more program instructions. For example, one or more of the procedures or operations described above may be embodied by computer program instructions. In this regard, the computer program instructions which embody the procedures or operations described above may be stored by a memory 404 of an apparatus (e.g., user equipment (UE)) employing a disclosed embodiment and executed by a processor 402. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

What is claimed is:

1. A method of communication, the method comprising:
determining that a user equipment (UE) is associated with an existing home routed-session breakout (HR-SBO) packet data unit (PDU) session;
sending a request for a data network name (DNN) and single network slice selection assistance information (S-NSSAI) of the existing HR-SBO PDU session to a home-network exposure function (H-NEF), the request comprising information, wherein the information comprises at least one of the following:
an application function (AF) identifier associated with the UE associated with the existing HR-SBO PDU session; or
an internet protocol (IP) address of the UE associated with the existing HR-SBO PDU session; and
receiving, from the H-NEF, a response comprising the DNN and the S-NSSAI of a home public land mobile network (HPLMN) of the N-NEF.

2. The method of claim 1, further comprising:
based on the receiving the response comprising the DNN and the S-NSSAI of the home public land mobile network (HPLMN), performing at least one of storing, updating, or deleting information at a visited unified data repository (V-UDR) based on the DNN and the S-NSSAI (824) of the HPLMN.

3. The method of claim 1, further comprising:
receiving, from an application function (AF), a request to influence traffic for the UE associated with the existing HR-SBO PDU session to cause the V-NEF to influence traffic forwarding in a network currently serving the existing HR-SBO PDU session, wherein the request comprises the DNN and the S-NSSAI of the HPLMN.

4. The method according to claim 3, wherein the request to influence traffic further comprises a generic public subscription identifier (GPSI) for the UE associated with the existing HR-SBO PDU session.

5. The method according to claim 3, wherein the request to influence traffic further comprises an external identifier for the UE associated with the existing HR-SBO PDU session.

6. An apparatus for communication, the apparatus comprising:
at least one processor; and
at least one memory storing instructions that, when executed by the at least one processor, cause the apparatus to perform:
determining that a user equipment (UE) is associated with an existing home routed-session breakout (HR-SBO) packet data unit (PDU) session;
sending a request for a data network name (DNN) and single network slice selection assistance information (S-NSSAI) of the existing HR-SBO PDU session to a home-network exposure function (H-NEF), the request comprising information, wherein the information comprises at least one of the following:
an application function (AF) identifier associated with the UE associated with the existing HR-SBO PDU session; or
an internet protocol (IP) address of the UE associated with the existing HR-SBO PDU session; and
receiving, from the H-NEF, a response comprising the DNN and the S-NSSAI of a home public land mobile network (HPLMN) of the N-NEF.

7. The apparatus according to claim 6, wherein the instructions, when executed by the apparatus, further cause the apparatus to perform:
based on the receiving the response comprising the DNN and the S-NSSAI of the home public land mobile network (HPLMN), performing at least one of storing, updating, or deleting information at a visited unified data repository (V-UDR) based on the DNN and the S-NSSAI of the HPLMN.

8. The apparatus of claim 6, wherein the at least one memory storing instructions, when executed by the at least one processor, cause the apparatus to perform:
receiving, from an application function (AF), a request to influence traffic for the UE associated with the existing HR-SBO PDU session to cause the apparatus to influence traffic forwarding in a network currently serving the existing HR-SBO PDU session, wherein the request comprises the DNN and the S-NSSAI of the HPLMN.

9. The apparatus according to claim 8, wherein the request to influence traffic further comprises a generic public subscription identifier (GPSI) for the UE associated with the existing HR-SBO PDU session.

10. The apparatus according to claim 8, wherein the request to influence traffic further comprises an external identifier for the UE associated with the existing HR-SBO PDU session.

11. A non-transitory computer-readable storage medium storing instructions that, when executed by an apparatus for communication, cause the apparatus to perform:
determining that a user equipment (UE) is associated with an existing home routed- session breakout (HR-SBO) packet data unit (PDU) session;
sending a request for a data network name (DNN) and single network slice selection assistance information (S-NSSAI) of the existing HR-SBO PDU session to a home-network exposure function (H-NEF), the request comprising information, wherein the information comprises at least one of the following:
an application function (AF) identifier associated with the UE associated with the existing HR-SBO PDU session; or
an internet protocol (IP) address of the UE associated with the existing HR-SBO PDU session; and
receiving, from the H-NEF, a response comprising the DNN and the S-NSSAI of a home public land mobile network (HPLMN) of the N-NEF.

12. The non-transitory computer-readable storage medium according to claim 11, wherein the instructions, when executed by the apparatus, further cause the apparatus to perform:
based on the receiving the response comprising the DNN and the S-NSSAI of the home public land mobile network (HPLMN), performing at least one of storing, updating, or deleting information at a visited unified data repository (V-UDR) based on the DNN and the S-NSSAI of the HPLMN.

13. The non-transitory computer-readable storage medium according to claim 11, wherein the instructions, when executed by the apparatus, further cause the apparatus to perform:
receiving, from an application function (AF), a request to influence traffic for the UE associated with the existing HR-SBO PDU session to cause the apparatus to influence traffic forwarding in a network currently serving the existing HR-SBO PDU session, wherein the request comprises the DNN and the S-NSSAI of the HPLMN.

14. The non-transitory computer-readable storage medium according to claim 13, wherein the request to influence traffic further comprises a generic public subscription identifier (GPSI) for the UE associated with the existing HR-SBO PDU session.

15. The-transitory computer-readable storage medium according to claim 13, wherein the request to influence traffic further comprises an external identifier for the UE associated with the existing HR-SBO PDU session.

16. An apparatus for communication, the apparatus comprising:
at least one processor; and
at least one memory storing instructions that, when executed by the at least one processor, cause the apparatus to perform:
receiving a request comprising information, wherein the information comprises at least one of the following:
an application function (AF) identifier associated with a user equipment (UE) that is associated with an existing home routed-session breakout (HR-SBO) packet data unit (PDU) session; or
an internet protocol (IP) address of the UE that is associated with the existing HR-SBO PDU session;
determining, based on the information, a data network name (DNN) and single network slice selection assistance information (S-NSSAI) of the existing HR-SBO PDU session associated with the UE; and
sending, in a response to the receiving the request, the DNN and the S-NSSAI that are determined.

17. The apparatus according to claim 16, wherein the receiving comprises receiving the request from a visited network exposure function (V-NEF), and wherein the request comprises the AF identifier and the IP address of the UE associated with the existing HR-SBO PDU session.
